(19) United States
(12) Patent Application Publication
(10) Pub. No.: US 2009/0122466 A1
(43) Pub. Date: May 14, 2009

(54) ELECTROCHEMICAL CAPACITORS

(75) Inventor: Nicole L. Blankenbeckler, (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(73) Assignee: E. I. DU PONT DE NEMOURS AND COMPANY

(21) Appl. No.: 12/266,786

(22) Filed: Nov. 7, 2008

Related U.S. Application Data
(60) Provisional application No. 61/002,601, filed on Nov. 9, 2007.

(51) Int. Cl. H01G 9/02

(52) U.S. Cl. 361/502; 361/503

(57) ABSTRACT

The present invention relates to the field of capacitors, and in particular electrochemical double layer capacitors which include separators comprising a porous layer of polymeric nanofibers and an antioxidant.

### CROSS-REFERENCE TO RELATED APPLICATION

This application claims priority under 35 U.S.C. §119 from U.S. Provisional Application Ser. No. 61/002,601 (filed Nov. 9, 2007), the disclosure of which is incorporated by reference herein for all purposes as if fully set forth.

### FIELD OF THE INVENTION

The present invention relates to the field of capacitors, and in particular electrochemical double layer capacitors which include separators comprising a porous layer of polymeric nanofibers and an antioxidant.

### BACKGROUND

Electrochemical capacitors, also known as ultracapacitors, supercapacitors, Electrochemical Double Layer Capacitors (EDLC), pseudocapacitors, and hybrid capacitors are energy storage devices that have considerably more specific capacitance then conventional capacitors. Charge storage in electrochemical capacitors is a surface phenomenon that occurs at the interface between the electrodes, typically carbon, and the electrolyte. The separator absorbs and retains the electrolyte thereby maintaining close contact between the electrolyte and the electrodes. The role of the separator is to electrically insulate the positive electrode from the negative electrode and to facilitate the transfer of ions in the electrolyte, during charging and discharging.

There are three different types of electrochemical capacitors depending on the structure of their electrodes and the nature of their electrolyte: (a) Capacitors having an organic electrolyte and active carbon electrodes with a large specific surface area lying in the range 1000 m²/g to 3000 m²/g, and which operate electrostatically; (b) Capacitors having an aqueous electrolyte and transition metal oxide electrodes, which operate essentially on the basis of surface electrochemical reactions, the mean specific surface area of the oxides used being 100 m²/g; and (c) Capacitors having electrodes of electronically conductive polymers such as polypyrrole or polyaniline.

All symmetrical electrochemical capacitors use high surface area carbon electrodes, while the asymmetrical electrochemical capacitors usually have one high surface area electrode and the other electrode is one from the following electrodes—LiCoO₂, NiOOH, graphitic carbon, RuO₂ etc. The typical electrolytes used in electrochemical capacitors are −30-35% KOH for aqueous capacitors; 1 M tetraethylammonium fluoroborate (TEABF₄) in Acetonitrile or 1M TEABF₄ in Propylene Carbonate for non-aqueous capacitors; and 1 M LiPF₆ in carbonate solvents as electrolytes for asymmetrical capacitors. Typical separators used in electrochemical capacitors are either paper (cellulose based) or polymeric separators made of polyethylene, polypropylene, PET, PTFE, polyamide etc.

Electrochemical double layer capacitors are commonly used in applications which require a burst of power and quick charging; therefore it is desired to lower the ionic resistance within the capacitor and to increase the capacitance per unit volume. If the ionic resistance of the separator is too high, then during high current charging and discharging, the voltage drop will be significant resulting in poor power and energy output. It would be desirable to have a separator having reduced thickness with high porosity and low resistance, yet still able to maintain its insulating properties by keeping the positive and negative electrodes apart thus avoiding the development of short-circuits, which can ultimately lead to self-discharge. Capacitor separators should obstruct the electrophoretic migration of charged carbon particles released from one of the electrodes towards the other electrode, referred to as a “soft short-circuit” or “soft short,” to reduce the likelihood of self-discharge. Such obstruction is also referred to herein as “soft short barrier.” As electrochemical double layer capacitors are typically made in a cylindrically wound design in which the two carbon electrodes and separators are wound together, separators having high strength are desired to avoid short-circuits between the two electrodes. Additionally, as the capacitance of the capacitor depends on the amount of active material present within the volume of the capacitor, a thinner separator is desired.

Conventional double layer capacitor separators include wet-laid cellulose based paper that are not stable at high temperature (i.e., greater than 140° C.) or high voltage (i.e., greater than 3 V) and have unacceptable moisture adsorption. Impurities present in the separator cause problems at higher voltages. Microporous polyethylene and polypropylene films have also been used, but have undesirably high ionic resistance and poor high temperature stability. It would be desirable to have capacitor separators with improved combinations of stability at high temperature and voltage, barrier to the electrophoretic migration of particles from one electrode to the other, lower ionic resistance and higher strength.

Low resistance electrochemical capacitors are ideally suited for high power applications. It is very important that the capacitors maintain low resistance during the life of the capacitors to provide high power for the end use application. One way of measuring or tracking ongoing capacitor performance is the resistance rise rate, which is the upward drift in resistance over time towards unacceptably high levels. Resistance rise rate is a function of the overall stability of the system relative to time and the number of times a device cycles. This test is also known as DC life test and the exact operating conditions (temperature, cell voltage, etc) depend on the cell design voltage and the target application. Typically, this test is done at 2.5V and 65 C, but as capacitors evolve and are being pushed to higher level of performance, the measurement criteria for their performance is also getting more stringent.

Accordingly, as the field of electrochemical capacitor evolves, there is a continuing need for better separators and electrochemical capacitors that exhibit better stability and operational characteristics and do not show any significant rise in resistance during long term use in aggressive conditions.

### SUMMARY OF THE INVENTION

The present invention is directed to a capacitor having a separator comprising a porous layer of nanofibers having mean diameters in the range from about 50 nm to about 1000 nm, wherein the nanofibers comprise a polyamide and an antioxidant.

### BRIEF DESCRIPTION OF THE DRAWINGS

FIG. 1 is a comparison of cell resistance data during the DC life test of electrochemical capacitors with a cellulose separator and polyamide 6, 6 separators with and without antioxidant present.

### DETAILED DESCRIPTION OF THE INVENTION

The separators and electrochemical capacitors containing antioxidants in the polymer fibers thereof described in this invention show a significantly lower increase in resistance during long term usage.

The electrochemical capacitors of the present invention include capacitor separators having an improved combination of reduced thickness, reduced ionic resistance and good soft short barrier properties, providing a high resistance to short-circuiting. The separators useful in the capacitors of the invention have a high capacity to absorb electrolyte while maintaining excellent structural integrity and chemical and dimensional stability in use, such that the separators do not lose their soft short barrier properties even when saturated with electrolyte solution. The reduction in thickness enables the manufacture of capacitors having increased capacity, since the thinner the separator, the lower the overall thickness of the materials used in a capacitor; therefore more electrochemically active materials can be present in a given volume. The separators useful in the capacitors of the invention have low ionic resistance, therefore ions flow easily between the anode and the cathode.

The electrochemical capacitor of the invention can be an double layer capacitor utilizing carbon based electrodes with organic or nonaqueous electrolyte, for example a solution of acetonitrile or propylene carbonate and 1 M TEABF4 salt, or aqueous electrolyte, for example, 30 to 40% potassium hydroxide (KOH) solution.

The electrochemical capacitor of the invention can alternatively be a capacitor which relies on faradic reactions on at least one electrode. Such capacitors are referred to as “pseudo capacitors” or “redox capacitors.” Pseudo capacitors utilize carbon, noble metal hydrous oxide; modified transition metal oxide and conductive polymer based electrodes, as well as aqueous and organic electrolytes.

It has been found that electrochemical double layer capacitors can be made using polymeric nanofiber separators having improved combinations of stability at high temperatures, good barrier properties against soft shorts and lower ionic resistance. The separators made according to the invention can be calendered to provide small pore size, low thickness, good surface stability and high strength. The separators are stable at high temperatures and thus can withstand high temperature drying processes.

The capacitor of the present invention includes a separator comprising at least one porous layer of polymeric nanofibers having mean diameters in the range of between about 50 nm and about 1000 nm, even between about 50 nm and about 500 nm. The term “nanofibers” refers to fibers having diameters of less than 1,000 nanometers. Fibers having diameters in these ranges provide a separator structure with high surface area which results in good electrolyte absorption and retention due to increased electrolyte contact. The separator has a mean flow pore size of between about 0.01 μm and about 10 μm, even between about 0.01 μm and about 5 μm, and even between about 0.01 μm and about 1 μm. The separator has a porosity of between about 20% and about 90%, even between about 40% and about 70%. The high porosity of the separator also provides for good electrolyte absorption and retention in the capacitor of the invention.

A separator useful in the capacitor of the invention has a thickness of between about 0.1 mils (0.0025 mm) and about 5 mils (0.127 mm), even between about 0.1 mils (0.0025 mm) and about 3 mils (0.0762 mm). The separator is thick enough to prevent soft shorting between positive and negative electrode while allowing good flow of ions between the cathode and the anode. The thin separators create more space for the electrodes inside a cell and thus provide for improved performance and life of the capacitors of the invention.

The separator has a basis weight of between about 1 g/m² and about 30 g/m², even between about 5 g/m² and about 20 g/m². If the basis weight of the separator is too high, i.e., above about 30 g/m², then the ionic resistance may be too high. If the basis weight is too low, i.e., below about 1 g/m², then the separator may not be able to reduce shorting between the positive and negative electrode.

The separator has a Frazier air permeability of less than about 80 cfm/ft² (24 m³/min/m²), even less than about 25 cfm/ft² (7.6 m³/min/m²), and even less then 5 cfm/ft² (1.5 m³/min/m²). The separator has a ionic resistance of less then about 5 ohms-cm², even less then 2 ohms-cm², and even less then 1 ohms-cm² in 2 M lithium chloride in methanol electrolyte solutions,

Polymers useful for electroblowing nanofiber webs for use in the capacitors of the present invention are polyamides (PA), and preferably a polyamide selected from the group consisting of polyamide 6, polyamide 66, polyamide 612, polyamide 11, polyamide 12, polyamide 46, polyphthalamides (high temperature polyamide) and any combination or blend thereof.

To achieve the desired improvement in electrochemical capacitor performance, an antioxidant additive is used as stabilizer for the nanofiber polymer at concentrations between about 0.01 and about 5% by weight relative to the polyamide and especially preferably between about 0.05 and about 3% by weight. Especially good results are achieved if the concentration of antioxidant agent lies between about 0.1 and about 2.5% by weight relative to the polyamide used.

The process for making the nanofiber layer(s) of the separator for use in the capacitor of the invention is disclosed in International Publication Number WO2003/080905 (U.S. Ser. No. 10/822,325), which is hereby incorporated by reference. The antioxidant stabilizer is preferably incorporated into the spinning solution with the polymer to be spun, but may also be pre-incorporated into polymer before dissolution.

Antioxidants that are useful for this invention include: phenolic amides such as N,N′-hexamethylene bis(3,5-di-(tert)-butyl-4-hydroxyhydrocinnamamide) (Irganox 1098); amines such as various modified benzenamines (e.g. Irganox 5057); phenolic esters such as ethylenebis(oxyethylene)bis-(3-(5-tert-butyl-4-hydroxy-m-tolyl)-propionate (Irganox 245) (all available from Ciba Specialty Chemicals Corp., Tarrytown, N.Y.); organic or inorganic salts such as mixture of cuprous Iodide, potassium iodide, and Zinc salt of Octadecanoic acid available as Polyad 201 (from Ciba Specialty Chemicals Corp., Tarrytown, N.Y.), and mixture of cupric acetate, potassium bromide, and calcium salt of octadecanoic acid available as Polyad 1932-41 (from Polyad Services Inc., Earth City, Mo.); hindered amines such as 1,3,5-Triazine-2,4,6-triamine,N,N′″-[1,2-ethane-diyl-bis[[[4,6-bis-[butyl (1,2,2,6,6-pentamethyl-4-piperidinyl)amino]-1,3,5-triazine-2-yl]imino]-3,1-propanediyl]]bis[N′,N″-dibutyl-N′,N″-bis(1,2,2,6,6-pentamethyl-4-piperidinyl)-(Chimassorb 119 FL), 1,6-Hexanediamine, N,N′-bis(2,2,6,6-tetramethyl-4-piperidinyl)-polymer with 2,4,6-trichloro-1,3,5-triazine, reaction products with N-butyl-1-butanamine an N-butyl-2,2,6,6-tetramethyl-4-piperidinamine (Chimassorb 2020), and Poly[[6-[(1,1,3,3-tetramethylbutyl)amino]-1,3,5-triazine-2,4-diyl][2,2,6,6-tetramethyl-4-piperidinyl)imino]-1,6-hexanediyl[(2,2,6,6-tetramethyl-4-piperidinyl)imino]]) (Chimassorb 944) (all available from Ciba Specialty Chemicals Corp., Tarrytown, N.Y.); polymeric hindered phenols such as 2,2,4 trimethyl-1,2 dihydroxyquinoline (Ultranox 254 from Crompton Corporation, a subsidiary of Chemtura Corporation, Middlebury, Conn., 06749); hindered phosphites such as bis(2,4-di-t-butylphenyl) pentaerythritol diphosphite (Ultranox 626 from Crompton Corporation, a subsidiary of Chemtura Corporation, Middlebury, Conn., 06749); and Tris(2,4-di-tert-butyl-phenyl) phosphite (Irgafos 168 from Ciba Specialty Chemicals Corp., Tarrytown, N.Y.); 3-(3,5-di-tert-butyl-4-hydroxyphenyl)propionic acid (Fiberstab PA6, available from Ciba Specialty Chemicals Corp., Tarrytown, N.Y.), and combinations and blends thereof.

In one embodiment of the invention, the capacitor separator comprises a single nanofiber layer made by a single pass of a moving collection means through the process, i.e., in a single pass of the moving collection means under the spin pack. It will be appreciated that the fibrous web can be formed by one or more spinning beams running simultaneously over the same moving collection means.

The as-spun nanoweb of the present invention can be dried by transporting the web through a solvent stripping zone with hot air and infrared radiation, according to the process disclosed in co-pending U.S. patent application Ser. No. ______, (attorney docket no. TK4635, entitled “Solvent Stripping Process Utilizing an Antioxidant”), filed on even date herewith, and incorporated herein by reference in its entirety.

The as-spun nanoweb of the present invention can be calendered in order to impart the desired physical properties to the fabric of the invention, as disclosed in co-pending U.S. patent application Ser. No. 11/523,827, filed Sep. 20, 2006 and incorporated herein by reference in its entirety.

Separators useful in the capacitors of the invention can comprise either a single layer of polymeric nanofibers or multiple layers. When the separator comprises multiple layers, the multiple layers can be layers of the same polymeric fine fibers formed by multiple passes of the moving collection belt beneath the spin pack within the same process. The multiple layers can alternatively be layers of differing polymeric fine fibers. The multiple layers can have differing characteristics including, but not limited to, thickness, basis weight, pore size, fiber size, porosity, air permeability, ionic resistance and tensile strength.

### Test Methods

In the non-limiting examples that follow, the following test methods were employed to determine various reported characteristics and properties. “ASTM” refers to the American Society of Testing Materials. “ISO” refers to the International Standards Organization. “TAPPI” refers to Technical Association of Pulp and Paper Industry.

Basis Weight of the web was determined by ASTM D-3776, which is hereby incorporated by reference and reported in g/m².

Porosity was calculated by dividing the basis weight of the sample in g/m² by the polymer density in g/cm³ and by the sample thickness in micrometers and multiplying by 100 and subsequently subtracting from 100%, i.e., percent porosity=100−basis weight/(density thickness)×100.

Fiber Diameter was determined as follows. Ten scanning electron microscope (SEM) images at 5,000.times. Magnification was taken of each nanofiber layer sample. The diameter of eleven (11) clearly distinguishable nanofibers were measured from the photographs and recorded. Defects were not included (i.e., lumps of nanofibers, polymer drops, intersections of nanofibers). The average (mean) fiber diameter for each sample was calculated.

Thickness was determined by ASTM D1777, which is hereby incorporated by reference, and is reported in mils and converted to micrometers.

Ionic Resistance in organic electrolyte is a measure of a separator's resistance to the flow of ions, and was determined as follows. Samples were cut into small pieces (1.5 cm diameter) and soaked in 2 M solution of LiCl in methanol electrolyte. The separator resistance was measured using Solartron 1287 Electrochemical Interface along with Solartron 1252 Frequency Response Analyzer and the Zplot software. The test cell had a 0.3165 square cm electrode area that contacts the wetted spacer. Measurements were done at AC amplitude of 10 mV and the frequency range of 10 Hz to 500,000 Hz. The high frequency intercept in the Nyquist plot was the spacer resistance (in ohms). The separator resistance (ohms) was multiplied with the electrode area (0.3165 square cm) to determine ionic resistance in ohms-cm².

MacMullin Number (Nm) is a dimensionless number and is a measure of the ionic resistance of the separator, and is defined as the ratio of the resistivity of a separator sample filled with electrolyte to the resistivity of an equivalent volume of the electrolyte alone. It is expressed by:

Nm=(Rₛₑₚₐᵣₐₜₒᵣ×A_{electrode})/(ρ_{electrolyte}×tₛₑₚₐᵣₐₜₒᵣ)

where Rₛₑₚₐᵣₐₜₒᵣ is the resistance of the separator in ohms, A_{electrode} is the area of electrode in cm², ρ_{electrolyte} is the resistivity of electrolyte in ohms-cm, tₛₑₚₐᵣₐₜₒᵣ is the thickness of separator in cm. The resistivity of 2 M LiCl in methanol at 25° C. is 50.5 ohms-cm.

Frazier Air Permeability is a measure of air permeability of porous materials and is reported in units of ft³/min/ft². It measures the volume of air flow through a material at a differential pressure of 0.5 inches (12.7 mm) of the water. An orifice is mounted in a vacuum system to restrict flow of air through sample to a measurable amount. The size of the orifice depends on the porosity of the material. Frazier permeability is measured in units of ft³/min/ft² using a Sherman W. Frazier Co. dual manometer with calibrated orifice, and converted to units of m³/min/m².

Mean Flow Pore Size was measured according to ASTM Designation E 1294-89, “Standard Test Method for Pore Size Characteristics of Membrane Filters Using Automated Liquid Porosimeter” which approximately measures pore size characteristics of membranes with a pore size diameter of 0.05 m to 300 μm by using automated bubble point method from ASTM Designation F 316 using a capillary flow porosimeter (model number CFP-34RTF8A-3-6-L4, Porous Materials, Inc. (PMI), Ithaca, N.Y.). Individual samples (8, 20 or 30 mm diameter) were wetted with low surface tension fluid (1,1,2,3,3,3-hexafluoropropene, or “Galwick,” having a surface tension of 16 dyne/cm). Each sample was placed in a holder, and a differential pressure of air was applied and the fluid removed from the sample. The differential pressure at which wet flow is equal to one-half the dry flow (flow without wetting solvent) is used to calculate the mean flow pore size using supplied software.

### EXAMPLES

### Sample Preparation

Capacitor separators useful in capacitors of the present invention will be described in more detail in the following examples. An electroblowing apparatus as described in International Publication Number WO2003/080905 was used to produce the fine fiber separators as described in the Examples below.

Layers of nanofibers were made by electroblowing a solution of DuPont polyamide 66-FE 3218 polymer having a density of 1.14 g/cm³ (available from E.I. du Pont de Nemours and Company, Wilmington, Del.) at 24 weight percent in formic acid (available from Kemira Oyj, Helsinki, Finland). The nanofiber layer samples were formed by depositing the fibers directly onto the moving collection belt, either in a single pass (forming a single nanofiber layer) or multiple passes (forming multiple nanofiber layers) of the moving collection belt under the spin pack.

The as-spun nanoweb is dried by transporting the web through a solvent stripping zone with hot air and infrared radiation and calendered in order to impart the desired physical properties to the fabric of the invention.

### 2032 Coin Cell Assembly

The 2032 coin cell parts (Case, Cap, Gasket, Wave springs, Spacer disk) were made by Hohsen in Japan and bought from Pred Materials in New York, USA. All the parts were sonicated in ultra high pure water to clean them and then dried in the antechamber of the inert glovebox (Vacuum Atmosphere Company, Hawthorne, Calif.) operated with Argon atmosphere. The carbon electrodes were commercial grade electrodes coated on aluminum current collector. Unless otherwise stated, the electrodes were punched out with a 0.625 in diameter punch and then dried at 90 C for 18 hrs in vacuum. The electrode pieces were weighed on the balance after drying. The separator pieces were punched out with a 0.75 in diameter punch and then dried at 90 C for 18 hrs in vacuum. The large antechamber in the glovebox was used for drying electrodes and separator. Electrolyte (Digirena 1 M TEABF4 in Acetonitrile) was obtained from Honeywell (Morristown, N.J.) and the moisture content in the electrolyte was less then 10 ppm.

The coin cell assembly was done with a Hohsen crimper inside a glove box. The PP gaskets are attached to the top cap by pushing gaskets into the cap. One piece of carbon electrode is placed in the coin cell case and four drops of electrolyte are added using a plastic pipette. Two layers of separators are then placed on top of the wet electrodes followed by the other carbon electrode. Four more drops of the electrolyte are added to make sure both the electrodes and separator are completely wet. Those skilled in the art will appreciate that both the materials and the thickness of the separators can be varied considerably without affecting the overall functionality of the coin cell device. A spacer disk is placed on the carbon electrode followed by the wave spring and gasketed cap. The whole coin cell sandwich is crimped using a manual coin cell crimper from Hohsen. The crimped coin cell is then removed and the excess electrolyte is wiped and the cell is removed from the glove box for further conditioning and electrochemical testing.

### DC Life Test

The DC life test is an accelerated test to measure the long term performance and stability of electrochemical capacitors and its components. In this test the cell is stored at 65 C in an environmental chamber (from ESPEC, Hudsonville, Mich.) and the cell is maintained at 2.5 V for extended period of time and resistance, capacitance and gassing are monitored relative to time. The resistance rise rate as a function of time is used to characterize the life of electrochemical capacitors. Smaller increase in resistance corresponds to longer life capacitors and vice versa. All the cycling test, resistance measurement and DC life test was done using Arbin (College Station, Tex.) eight channel MSTAT potentiostat running with MITS PRO software.

The 2032 coin cells are conditioned by cycling them between 0.75 V and 2.5 V at 10 mA current for 5 cycles. Initial cell resistance is measured after the cell is conditioned. Fully charged cell was rested for 15 minutes before it was spiked by a high current pulse (˜100 mA) for 10 msec. The cell resistance is calculated from the voltage drop and pulse current using ohm's law. During the DC life test, the cells were stored at 65 C in a ESPEC (Hudsonville, Mich.) Environmental chamber and the cell voltage was maintained at 2.5V. Cell resistance was measured every 8 hours using current interrupt method described above.

### Comparative Example A

Comparative Example A is a commercial product made by Nippon Kodoshi Corporation (NKK) of Japan. The paper separator has a basis weight of 14.5 gsm and is typically used as separator for electrochemical double layer capacitors. The properties of the NKK separator are listed in Table 1.

### Comparative Example B

Comparative Example B was derived from a master nonwoven web prepared as set forth above, but without the addition of an antioxidant. The resulting master nonwoven web had a basis weight of 17 g/m² with fibers having an average fiber diameter of 267 nanometers. The properties of the nanofiber separator are listed in Table 1.

### Example 1

The Example was derived from a master nonwoven web prepared in the same manner as the master nonwoven web of the Comparative Example B, except 1 weight percent of antioxidant, Irganox 1098 (available from Ciba Specialty Chemicals Corp., Tarrytown, N.Y.), based on weight of polymer was added to the spinning solution. The resulting master nonwoven web had a basis weight of 16 g/m² with fibers having an average fiber diameter of 400 nanometers. The properties of the nanofiber separator are listed in Table 1.

TABLE 1

| | | | | | | Ionic |
|---|---|---|---|---|---|---|
| | | Thick- | Basis | Anti- | Fiber | Resistance |
| Sample | | ness | Weight | oxidant | diameter | (ohms- |
| No. | Material | (um) | (gsm) | (wt %) | (nm) | cm 2) |
| CE A | Cellulose | 35 | 14.5 | NA | — | 0.58 |
| CE B | PA 6,6 | 50 | 17 | 0 | 267 | 0.738 |
| 1 | PA 6,6 | 51.3 | 16 | 1 | 400 | 0.487 |

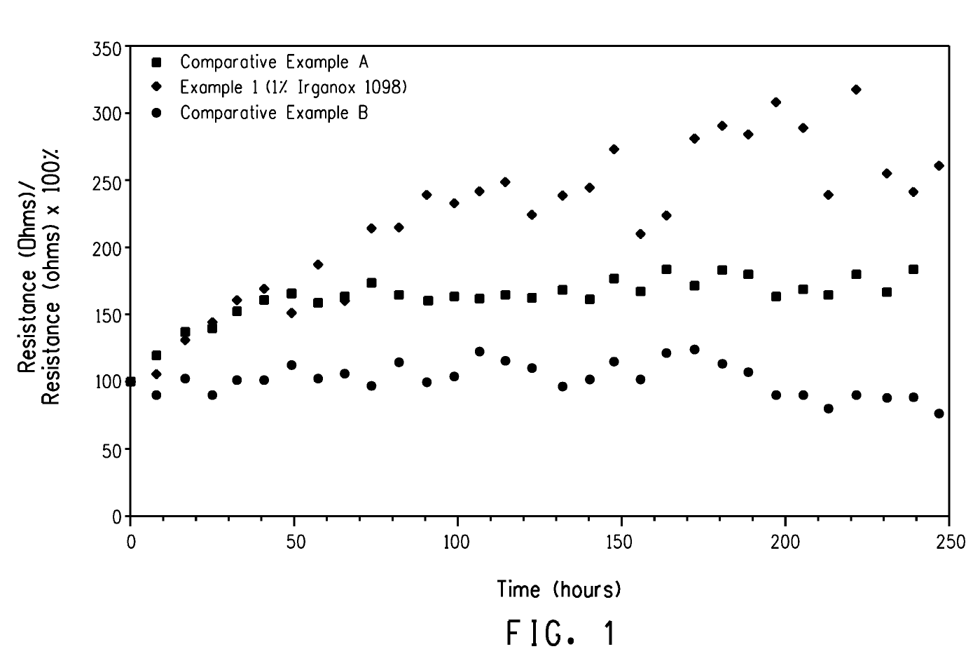

The 2032 coin cells were made with Comparative Examples A, B and Example 1 samples. All cells were conditioned and then tested in the DC life test to determine the long term performance of electrochemical capacitors. The resistance rise rate for all three samples was monitored as shown in FIG. 1. The results (after 240 hrs in DC life test) are reported in Table 2.

TABLE 2

| | Rate of Resistance | Resistance after 240 hrs |
|---|---|---|
| Sample Name | increase (milliohm/hr) | in life test (%) |
| CE B | 20.25 | 283.9 |
| CE A | 11.76 | 181.1 |
| 1 | 2.05 | 109 |

The unstabilized polyamide 6, 6 separators of Comparative Example B show a higher increase in resistance when compared with the micron NKK paper separator of Comparative Example A during the DC life test. However, the polyamide 6, 6 separators with 1% antioxidant of Example 1 had a very small increase in resistance, significantly lower than both Comparative Examples. This is also demonstrated in FIG. 1. The lower increase in cell resistance is indicative of a long lasting, high power electrochemical capacitor.

Although the present invention has been described with respect to various specific embodiments, various modifications will be apparent from the present disclosure and are intended to be within the scope of the following claims.

We claim:

1. A capacitor having a separator comprising a porous layer of nanofibers having mean diameters in the range from about 50 nm to about 1000 nm, wherein the nanofibers comprise a polyamide and an antioxidant.

2. The capacitor of claim 1 wherein the separator has a mean flow pore size of between about 0.01 μm and about 10 μm, a thickness of between about 0.1 mils (0.0025 mm) and about 5 mils (0.127 mm), a basis weight of between about 1 g/m² and about 30 g/m², a porosity of between about 20% and about 90%, a Frazier air permeability of less than about 80 cfm/ft² (24 m.³/min/m²) and a MacMullin number of between about 2 and about 15.

3. The capacitor of claim 1 wherein the separator has an ionic resistance of between about 0.1 ohms-cm² and about 5 ohms-cm² in 2 molar LiCl in methanol electrolyte solution.

4. The capacitor of claim 1 wherein the polyamide is selected from the group consisting of polyamide 6, polyamide 6,6, polyamide 6,12, polyamide 11, polyamide 12, polyamide 4,6, semi-aromatic polyamides and blends or combinations thereof.

5. The capacitor of claim 1 wherein the antioxidant is present at a level of about 0.01% to about 5% of the polyamide by weight.

6. The capacitor of claim 1 wherein the antioxidant is selected from the group consisting of phenolic amides, hindered phenols, phenolic esters, organic or inorganic salts of copper, hindered amines, polymeric hindered phenols, hindered phosphites, and combinations and blends thereof.

7. The capacitor of claim 1 wherein the resistance rise during a DC life test is less then 50%

8. The capacitor of claim 1 wherein the resistance rise during a DC life test is less then 20%
